(19) United States
(12) Patent Application Publication
(10) Pub. No.: US 2008/0156850 A1
(43) Pub. Date: Jul. 3, 2008

(54) APPARATUS AND METHOD FOR PREVENTING ACCUMULATION AND ADHESION OF WELD SPATTER

(75) Inventors: GARY ALDEN, Bettendorf, IA (US); PATRICK W. POLLOCK, Port Byron, IL (US); Don STABENOW, St. Olaf, IA (US)

Correspondence Address: MCKEE, VOORHEES & SEASE, P.L.C., 801 GRAND AVENUE, SUITE 3200, DES MOINES, IA, 50309-2721, US

(73) Assignee: GENESIS SYSTEMS GROUP, L.L.C., Davenport, IA (US)

(21) Appl. No.: 11/618,992

(22) Filed: Jan. 2, 2007

(51) Int. Cl. B23K 31/02; B23K 37/04; B23K 9/00; B05D 1/00

(52) U.S. Cl. 228/212; 228/47.1; 219/137 R; 427/445; 219/136

(57) ABSTRACT

A tooling fixture is adapted to preserve the dimensional accuracy of critical dimension locating components associated with the fixture. The tooling fixture has a plurality of component locators having a body with at least one surface for accurately constraining at least one component part within the tooling fixture. The surfaces of the component locators are exposed to weld spatter. A spatter resistant coating is applied to the surfaces of the component locators to protect their surfaces from accumulating weld spatter thereby preserving the dimensional repeatability of the tooling fixture and decreasing rework or scrap quantities resulting from the component parts being out of specification.

### FIELD OF THE INVENTION

The present invention relates to an apparatus and method for preventing the accumulation and adhesion of weld spattering and other manufacturing debris on critical components used to position and constrain component parts within a tooling fixture to thereby maintain the dimensional repeatability and part through-put of the tooling fixture while decreasing the amount of rework or scrap quantities resulting from the component parts failing to meet the correct specifications.

### BACKGROUND OF THE INVENTION

Fixture details or component locators for manufacturing are used to accurately position and constrain component parts within a tooling fixture. Typically some manufacturing process is performed on the component part or parts after the part(s) are accurately positioned and constrained in the tooling fixture. For example, to comply with the dimensional specifications for the finished component part, two component parts could be welded together within the tooling fixture by an arc welder as each is held in a specific position relative to the other using details or component locators. Ultimately, the capacity to keep details or component locators within a tooling fixture free and clear of debris, including weld spattering, metal chips and filings and other manufacturing byproducts is critically important to the dimensional repeatability of the tooling fixture. Therefore, there is a need to provide details or component locators having a coating to thereby prevent accumulation and adhesion of weld spattering and other manufacturing debris on the surfaces of the component locators.

Fixture details or component locators for manufacturing are often exposed to intense heat while the component parts are being manufactured. For example, fixture details or component locators, clamp arms and other components critical to the accuracy of the tooling fixture experience intense heat in the case where an arc welder is used to weld together or finish component parts within a tooling fixture. Some techniques exist to protect and preserve critical dimensional components and parts used in the manufacturing process and particularly in the production of component parts using a tooling fixture. These techniques include spraying the critical dimensional locating part with anti-spatter sprays. However, these sprays are not able to withstand the heat generated by an arc welder. An inability to withstand the heat from such tools as an arc welder ultimately breaks down the ability of the spray to prevent adhesion and accumulation of weld spattering. For example, hot molten steel or weld spatter, can burn through the coating and adhere to the surface of the critical dimension locating components and parts thereby affecting the dimensional accuracy of such components and parts. Therefore, there is a need to provide critical dimension locating components and parts used in a tooling fixture having a coating capable of withstanding the intense heat of the arc welding process thereby preventing the adhesion and accumulation of weld spatter on the surface of such components and parts. There is also a need to provide a coating that accomplishes all of the aforementioned features while minimally altering the dimensions of the critical dimension locating components and parts thereby maintaining the dimensional repeatability of the tooling fixture.

### BRIEF SUMMARY OF THE INVENTION

Therefore it is a primary object, feature, or advantage of the present invention to improve over the state of the art.

It is a further object, feature, or advantage of the present invention to provide critical dimension locating components and parts having a surface coating that prevents adhesion and accumulation of weld spatter and other manufacturing byproducts on the surface of such components and parts thereby preserving the dimensional repeatability of a tooling fixture.

Yet another object, feature, or advantage of the present invention is to provide critical dimension locating components and parts having a surface coating that resists degradation from the intense heat from an arc welder and thereby preserves the accumulation and adhesion resistance of such critical dimension locating components and parts to weld spatter.

A further object, feature, or advantage of the present invention is to provide critical dimension locating components and parts having a surface coating wherein the coating is a spatter resistant coating such as BALINIT HARDLUBE as described, e.g., in U.S. Pat. No. 5,707,748 (Bergmann), the description of which is incorporated herein by reference.

Yet another object, feature, or advantage of the present invention is to provide critical dimension locating components and parts used in a tooling fixture having a coating that prevents the adhesion and accumulation of weld spatter while minimally altering the dimension of such components and parts thereby preserving the dimensional repeatability of the tooling fixture.

One or more of these and/or other objects, features, or advantages of the present invention will become apparent from the specification and claims that follow.

According to one aspect of the present invention, a tooling fixture adapted to preserve critical dimensional locating components associated with the fixture to thereby preserve dimensional repeatability of the tooling fixture and decrease rework or scrap quantities resulting from out of specification component parts is disclosed. The tooling fixture has a plurality of component locators having a body with at least one surface for accurately constraining at least one component part within the tooling fixture. The surfaces of the component locators are exposed to a manufacturing process associated with manufacturing the component part. A coating is applied to the surfaces of the component locators for protecting them from the manufacturing process. The coating preserves the dimensional repeatability of the tooling fixture and thereby decreases rework or scrap quantities resulting from the component parts being out of specification. In the preferred form, the coating is Balinit Hardlube manufactured by Balzers, Inc as set forth and described in U.S. Pat. No. 5,707,748. The manufacturing processes include the surface of the component locators being exposed to abrasion, heat, weld spattering, metal chips and filings and other manufacturing byproducts resulting from work performed on the component part. The coating prevents weld spattering from collecting on and adhering to the surfaces of the component locators when a welder is used in the manufacturing process.

A new method for preventing weld spattering from collecting on and adhering to critical dimensional locating components thereby preserving the economic advantage associated with maximizing component through-put in a tooling fixture and reducing rework or scrap quantities resulting from out of specification parts is also disclosed. The method includes providing a plurality of component locators having a body with at least one surface for accurately constraining at least one component part within the tooling fixture where the surfaces of the component locators are exposed to weld spattering while the component parts are welded. The method includes coating the surfaces of the component locators with a Balinit Hardlube coating to prevent adhesion of weld spattering and maintain dimensional repeatability of the tooling fixture. In the preferred form, the method includes providing a plurality of clamping arms associated with the plurality of component locators for controlling the position of the component locators in the tooling fixture and coating the plurality of clamping arms with the Balinit Hardlube coating for preventing adhesion of weld spatter and increasing their abrasion resistance.

### BRIEF DESCRIPTION OF THE DRAWINGS

While the specification concludes with claims particularly pointing out and distinctly claiming the invention, it is believed that the present invention will be better understood from the following description taken in conjunction with the accompanying drawings in which:

FIG. 1 is an isometric illustration of a tooling fixture with component locators for positioning the component part(s) in the tooling fixture according to one exemplary embodiment of the present invention.

### DETAILED DESCRIPTION OF THE PREFERRED EMBODIMENTS

The present invention includes a number of aspects all of which have broad and far-reaching application. One aspect of the present invention relates to the use of critical dimension locating components or component locators within a tooling fixture having a surface coating for preventing weld spatter from collecting on and adhering to the surface of the component locators thereby maintaining the dimensional repeatability of the tooling fixture. In the preferred embodiment, the present invention relates to the use of component locators having a surface coating wherein the coating is a spatter resistant coating such as BALINIT HARDLUBE manufactured by Balzers, Inc., and described e.g., in U.S. Pat. No. 5,707,748. The preferred spatter resistant coating, BALINIT HARDLUBE, has the following properties. The BALINIT HARDLUBE material is made of titanium aluminum nitride/tungsten (TiAIN) and tungsten carbide/carbon (WC/C) materials, has a microhardness of 3,000 (HV 0.05), coefficient of friction against steel (dry) of 0.15-0.2, a coating thickness of 2-6 μm, a maximum service temperature of 1,470-1,830 degrees Fahrenheit, a coating color of black-grey, and is formed by combining hard and lubricant coating layers (TiAIN/WC/C).

Although specific embodiments are described herein, the present invention is not to be limited to these specific embodiments. The present invention contemplates numerous other options in the design and use of the spatter resistant component locators.

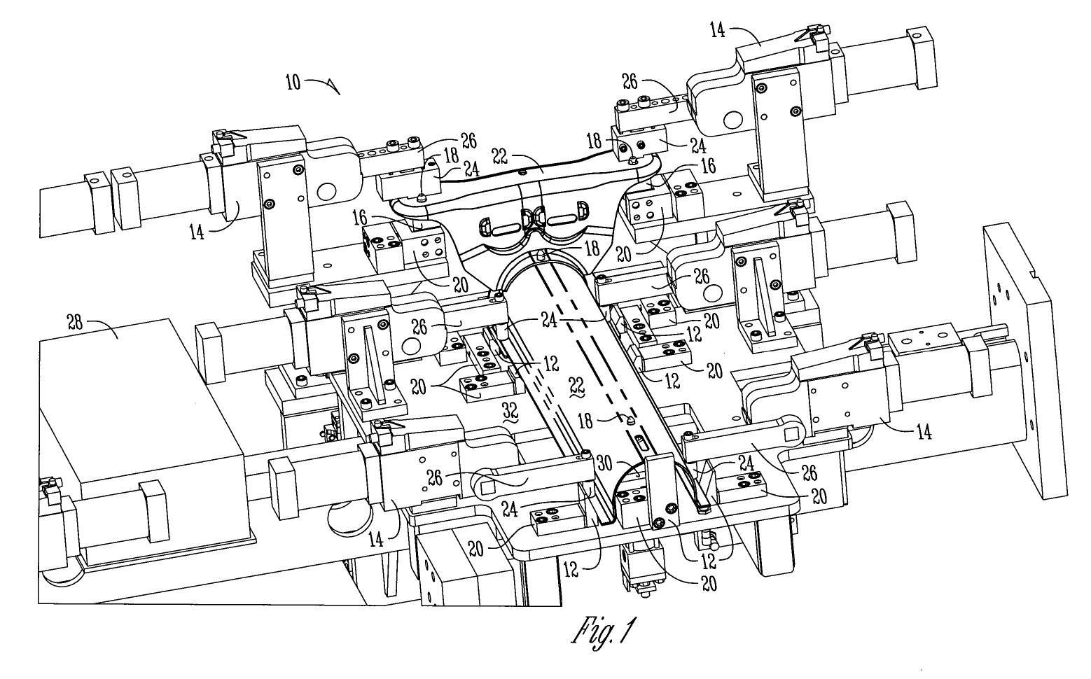

FIG. 1 shows an isometric illustration of a tooling fixture with component locators for positioning the component part(s) in the tooling fixture according to one exemplary embodiment of the present invention. By way of example only, a tooling fixture 10 is illustrated in FIG. 1. The tooling fixture 10 has a plurality of fixture details or components (i.e., rough locators 12, power clamps 14, gage pins 18, datum locks 16, L-blocks 20, clamp arms 26, pin blocks 30 and clamp fingers 24) used as locators for component part(s) 22 to correctly position and constrain the component part(s) 22 within the tooling fixture 10. For example, component part(s) 22 is properly positioned and constrained within the tooling fixture 10 using rough locators 12, gage pins 18 and clamp fingers 24. More specifically, the rough locators 12 control the position of the component part(s) 22 while the clamp fingers 24 constrain movement of the component part(s) 22. Gage pins 18 help to further position the component part(s) 22 within the tooling fixture 10. To constrain the component part(s) 22 within the tooling fixture 10, clamp fingers 24 are attached to clamp arms 26. The clamp arms 26 are attached to power clamps 14. Thus, the component part(s) 22 are constrained within the tooling fixture 10 by actuating power clamps 14 and moving clamp arms 26 with attached clamp fingers 24 on top of the component part(s) 22, thereby constraining movement of the component part(s) 22. The L-blocks 20 are positioned on the tooling fixture 10 to support rough locators 12. Similarly, the end blocks 16 rest upon pin blocks 30 to support gage pins 18.

In operation and by way of further example, the tooling fixture 10 provides an environment where the component part(s) 22 may be fixed in position relative to each other or the tooling fixture 10 while some manufacturing process, such as arc welding, is performed on the component part(s) 22. This is accomplished as the component part(s) 22 are accurately positioned on the bed 32 of the tooling fixture to some exact dimensional location using rough locators 12 and gage pins 18. For example, as shown in FIG. 1, the first component part 22 rests on the bed 32 of the tooling fixture 10. Rough locators 12 control the position of the first component part 22. Similarly, gage pins 18 work in concert with rough locators 12 to control the position of the first component part 22. A second component part 22 is positioned relative to the first using gauge pins 18. The second component part 22 is constrained in movement using clamp fingers 24. Thus, both component part(s) 22 are positioned relative to each other and the tooling fixture 10. Once the component part(s) 22 are accurately positioned in the tooling fixture 10, any manufacturing process may be performed on the component part(s) 22, such as arc welding, drilling, screwing, bolting, riveting, or some other manufacturing process. Upon completion of the manufacturing processes performed on the component part(s) 22, the process of removing the finished component part(s) 22 from the tooling fixture 10 and replacing with new component part(s) 22 occurs.

In the case where an arc welder is used to perform work on the component part(s) 22, these parts, the rough locators 12, gage pins 18, and clamp fingers 24, as well as other parts associated with the tooling fixture 10 are exposed to intense heat, high temperatures and weld spattering. For example, the arc welding process can generate an arc that has a temperature of 3,000 degrees Fahrenheit (over 1,600 degrees Celsius). Thus, critical dimension locating components can be subject such temperatures depending on their distance from the arc. In some cases, the arc can be within 4-5 inches from the critical dimension locating components. Because of the intensity of the heat, many materials used as spatter resistant coatings fail to maintain their spatter resistance, thus permitting weld spatter to accumulate and adhere to the surface of these critical dimension locating components. For example, in the case where the component part(s) 22 are steel, such as carbon steel, the hot molten spatter resulting from welding the steel has a temperature between 2,500-2,800 degrees Fahrenheit or the melting temperature of the carbon steel. Because of the temperature of the hot molten spatter, the spatter tends to hot weld to the surface of the critical dimension locating components upon contact, unless the surface of the critical dimension locating components is capable of preventing the hot weld process from occurring (e.g., keep the hot molten spatter from adhering to the surface of the critical dimension locating components). If the surface coating is not capable of withstanding the intense heat from the arc welder, the hot weld spatter pots and destroys the outer surface of these critical dimension locating components.

A tooling fixture's ability, such as the exemplary fixture 10 shown in FIG. 1, to produce component part(s) 22 to specification is dependant on the dimensional accuracy of the individual component locators, such as the rough locators 12, gage pins 18, and clamp fingers 24. Thus, it is critically important that these components maintain their dimensional accuracy as well as remain free and clear from the collection, accumulation or buildup of debris on their surfaces. For example, if weld spattering were permitted to accumulate and adhere to such component locators as the gage pins 18 or rough locators 12, the dimensional repeatability of the tooling fixture 10 is significantly impaired. If the tooling fixture 10 is not capable of accurately positioning the component part(s) 22 within the fixture on a repeatable basis, the component part(s) 22 can be welded out of specification leading to component part(s) 22 needing repair, rework, or being scrapped. The associated lower tooling fixture 10 throughput will have a negative impact on production and ultimately lower company profitability. Moreover, component locators unable to maintain their dimensional accuracy because of weld spatter accumulation and adhesion often have to be replaced with new components. Each component failing to meet its planned longevity, thus requiring early replacement, represents an increase in the cost of the component part(s) 22 manufactured using the tooling fixture 10.

The construction or manufacture of critical dimension locating components or component locators, such as rough locators 12, gage pins 18 and clamp fingers 24, are most machined to maintain their dimensional accuracy. The material used to construct these components must be able to withstand weld spattering, and the intense heat associated with the arc welding process. For example, if the hot molten spatter adheres to the surface of the critical dimension locating components this creates dimensional inaccuracies and ultimately pits and destroys the outer surface of such components. Many machineable materials or materials that are cost effective to machine are not capable of withstanding the intense heat from an arc welder and thus allow the accumulation and adhesion of weld spattering on their surfaces. For instance, soft materials are easier to machine, but typically have a lower melting temperature. Conversely, materials capable of withstanding intense temperatures and preventing the accumulation and adhesion of weld spatter are difficult and very expensive to machine as well as costly to purchase. For example, Beryllium Copper cannot be used as a material for such critical dimension locating components because the material is difficult and risky to machine. Anviloy 1150 is another perspective material for constructing such critical dimension locating components, however, Anviloy 1150 is difficult to machine, has long wait times, and is costly to purchase.

Another option for protecting and preserving the integrity and dimensional accuracy of the surface of the component locators used for constraining and accurately positioning the component part(s) 22 within the tooling fixture 10 is to coat their surfaces with a anti-spatter spray. However, these sprays cannot withstand the intense heat associated with an arc welder and still retain the ability to prevent the accumulation and adhesion of weld spatter on the surfaces of the component locators. Therefore, in the preferred embodiment, the critical dimension locating components having the spatter resistant coating must be capable of withstanding the intense heat of an arc welder (e.g., the spatter resistant coating must be capable of withstanding temperatures up to the temperature of the arc welder or 3,000 degrees Fahrenheit) and still prevent the accumulation and adhesion of weld spatter having a temperature at or near the melting temperature of the material used for the components part(s). For instance, if the component part(s) 22 are carbon steel the resulting weld spatter from welding the component part(s) 22 can have a temperature at or near the melting temperature for carbon steel or between 2,500-2,800 degrees Fahrenheit.

The tooling fixture 10 illustrated in FIG. 1 is used for exemplary purposes only. Critical component locators such as those illustrated in FIG. 1 are used in many manufacturing processes. Moreover, these critical dimension locator components must be capable of withstanding intense heat, high temperatures, weld spatter, and other hot manufacturing byproducts. Thus, in any situation where such components are exposed to hot molten spatter and intense heat, the spatter resistant coating may be used to preserve or protect such components without hampering the performance of the tooling fixture. Additionally, because such critical dimension locating components, as noted by example in FIG. 1, are critical to correctly positioning the component part(s) 22, these critical dimension locating components must maintain their dimensional accuracy notwithstanding such coating.

Accordingly, in the preferred embodiment, the spatter resistant coating has a thickness such that when applied to the critical dimension locating components it minimally alters the dimension of the critical dimension locating components and does not effect the dimensional repeatability or integrity of the tooling fixture 10 or any other tooling fixture or manufacturing process in which such critical dimension locating components are used.

The preferred embodiment of this present invention has been set forth in the drawings and specification and those specific terms are employed, these are used in the generically descriptive sense only and are not used for the purposes of limitation. Changes in the formed proportion of parts as well in the substitution of equivalence are contemplated as circumstances may suggest are rendered expedient without departing from the spirit and scope of the invention as further defined in the following claims.

What is claimed is:

1. A tooling fixture having critical dimension locating components adapted to accurately position and constrain at least one component part within the tooling fixture by preventing the accumulation and adhesion of weld spatter and thereby preserving the dimensional repeatability of the tooling fixture and decreasing rework or scrap quantities resulting from the at least one component part being out of specification, the tooling fixture comprises:
a plurality of component locators having a body with at least one surface for accurately positioning and constraining the at least one component part within the tooling fixture; and
a coating on the at least one surface to prevent the accumulation and adhesion of weld spatter on the at least one surface for preserving the dimensional repeatability of the tooling fixture by maintaining the dimensional accuracy of the plurality of component locators.

2. The tooling fixture of claim 1 wherein the coating is a spatter resistant coating.

3. The tooling fixture of claim 2 wherein the spatter resistant coating prevents weld spatter from an arc welder from collecting on and adhering to the at least one surface of the plurality of component locators.

4. The tooling fixture of claim 3 wherein the spatter resistant coating protects the at least one surface of the plurality of component locators at a temperature of operation for the arc welder.

5. The tooling fixture of claim 4 wherein the temperature of operation for the arc welder at least 3,000 degrees Fahrenheit.

6. A tooling fixture having the advantage of repeatably manufacturing dimensionally accurate parts comprising:
a plurality of component locators having a body with at least one surface for accurately positioning and constraining at least one component part within the tooling fixture and the at least one surface to be exposed to weld spatter while the at least one component part is welded; and
a spatter resistant coating on the at least one surface for preventing weld spatter from accumulating and adhering to the at least one surface to thereby preserve the dimensional repeatability of the tooling fixture and decrease rework or scrap quantities resulting from the at least one component part being out of specification.

7. The tooling fixture of claim 6 wherein the spatter resistant coating has a thickness of less than 6 microns to thereby maintain the dimensional accuracy of the plurality of component locators.

8. The tooling fixture of claim 7 wherein the spatter resistant coating prevents weld spatter from accumulating and adhering to the at least one surface of the plurality of component locators at a temperature of operation for an arc welder.

9. The tooling fixture of claim 8 wherein the temperature of operation for the arc welder exceeds a maximum service temperature for the spatter resistant coating.

10. The tooling fixture of claim 9 wherein the temperature of operation for the arc welder is a temperature at or near 3,000 degrees Fahrenheit.

11. The tooling fixture of claim 10 wherein the maximum service temperature for the spatter resistant coating is between 1,472 and 1,832 degrees Fahrenheit.

12. A method for preventing weld spatter from accumulating on and adhering to critical dimensional locating components used in a tooling fixture to thereby preserve the dimensional accuracy of the tooling fixture and the economic advantage associated with maximizing through-put of parts in the tooling fixture while reducing rework or scrap quantities resulting from out of specification parts, the method comprising:
providing a plurality of component locators having a body with at least one surface for accurately positioning at least one component within the tooling fixture and the at least one surface being exposed to weld spatter from an arc welder while the at least one component is welded;
coating the at least one surface with a spatter resistant coating for preventing weld spatter from accumulating on and adhering to the at least one surface of the plurality of component locators;
constraining the at least one component part within the tooling fixture to specification using the at least one surface of the plurality of component locators; and
welding the at least one component part to specification thereby preserving the dimensional repeatability of the tooling fixture and decreasing rework or scrap quantities resulting from the at least one component part being out of specification.

13. The method of claim 12 wherein the spatter resistant coating prevents weld spatter from accumulating and adhering to the at least one surface of the plurality of component locators at a temperature of operation for an arc welder.

14. The method of claim 13 wherein the temperature of operation for the arc welder exceeds a maximum service temperature for the spatter resistant coating.

15. The method of claim 14 wherein the temperature of operation for the arc welder operates at a temperature at or near 3,000 degrees Fahrenheit.

16. The method of claim 15 wherein the maximum service temperature for the spatter resistant coating is between 1,472 and 1,832 degrees Fahrenheit.

17. The method of claim 12 further comprising reloading the tooling fixture with another component by accurately positioning and constraining the component within the tooling fixture using the at least one surface free of weld spatter.

18. A method for preventing weld spattering from collecting on and adhering to critical dimensional locating components having the advantage of preserving the dimensional accuracy of a tooling fixture and the economic advantage associated with maximizing through-put of parts in the tooling fixture while reducing rework or scrap quantities resulting from out of specification parts, the method comprising:
providing a plurality of component locators having a body with at least one surface for accurately constraining at least one component part within the tooling fixture and the at least one surface being exposed to weld spatter from an arc welder while the at least one component part is being welded; and
coating the at least one surface with a spatter resistant coating for preventing weld spatter from accumulating on and adhering to the at least one surface of the plurality of component locators thereby maintaining the dimensional repeatability of the tooling fixture.

19. The method of claim 18 wherein the at least one component part is steel.

20. The method of claim 19 wherein the melting temperature of steel is 2,500 to 2,800 degrees Fahrenheit.

21. The method of claim 20 wherein weld spatter from the arc welder is molten steel.
